(19) United States
(12) Patent Application Publication
(10) Pub. No.: US 2007/0247499 A1
(43) Pub. Date: Oct. 25, 2007

(54) MULTI-FUNCTION THERMOPLASTIC ELASTOMER LAYER FOR REPLACEABLE INK TANK

(76) Inventors: James Daniel Anderson, Jr., Harrodsburg, KY (US); Trevor Daniel Gray, Versailles, KY (US)

Correspondence Address: Lexmark International, Inc.;Neill R. Kahle, Jr. Esq., 740 West New Circle Road, Lexington, KY, 40550, US

(21) Appl. No.: 11/379,330

(22) Filed: Apr. 19, 2006

(51) Int. Cl. B41J 2/175

(52) U.S. Cl. 347/86

(57) ABSTRACT

A replaceable tank for attachment to a micro-fluid ejection head containing a multi-function thermoplastic elastomer layer, a method for sealing an exit port of a removable fluid reservoir for a micro-fluid ejection head using the multi-function thermoplastic elastomer layer, and a method for improving the handling and shipping of replaceable fluid cartridges for micro-fluid ejection heads using the multi-function thermoplastic elastomer layer. The multi-function thermoplastic elastomer layer is disposed in the exit port and on at least a portion of an outer surface of the reservoir.

### TECHNICAL FIELD

The disclosure relates to micro-fluid ejection heads, and in particular to structures suitable for improved assembly procedures for micro-fluid ejection head device components.

### BACKGROUND AND SUMMARY

Micro-fluid ejection heads are useful for ejecting a variety of fluids including inks, cooling fluids, pharmaceuticals, lubricants and the like. A widely used micro-fluid ejection head is in an ink jet printer. Ink jet printers continue to be improved as the technology for making the micro-fluid ejection heads continues to advance. New techniques are constantly being developed to provide low cost, highly reliable printers which approach the speed and quality of laser printers. An added benefit of ink jet printers is that color images can be produced at a fraction of the cost of laser printers with as good or better quality than laser printers. All of the foregoing benefits exhibited by ink jet printers have also increased the competitiveness of suppliers to provide comparable printers and supplies for such printers in a more cost efficient manner than their competitors.

Micro-fluid ejection devices may be provided with permanent, semi-permanent, or replaceable ejection heads. Since the ejection heads require unique and relatively costly manufacturing techniques, some ejection devices are provided with permanent or semi-permanent ejection heads. The fluid or fluids supplied to ejection heads, however, are often supplied via one or more replaceable fluid reservoirs. Fluid flow between the fluid reservoir and ejection head is typically accomplished via an exit port in the fluid reservoir. Filtration structures and components attached thereto are provided to cooperate with the one or more removable fluid reservoirs to provide fluid flow and fluid seals between the reservoirs and the filtration structures. Other components enable improved handling of the replaceable cartridges during storage, shipment, and use. For example, the fluid reservoirs must be substantially sealed in some manner for handling and shipping purposes before such reservoirs are engaged with an ejection head and must not leak fluids when attached to the ejection head.

Moreover, the replaceable fluid reservoirs must be made with physical characteristics that allow a user to easily handle the replaceable fluid reservoirs in close proximity with other objects including other engaged fluid reservoirs while a new reservoir is being engaged with an ejection head. Accordingly, provision and assembly of multiple components for multiple functions increases the cost of manufacture of the micro-fluid ejection devices.

In view of the foregoing, exemplary embodiments of the disclosure provide a replaceable tank for attachment to a micro-fluid ejection head containing a multi-function thermoplastic elastomer layer, a method for sealing an exit port of a removable fluid reservoir for a micro-fluid ejection head, and a method for improving the handling and shipping of replaceable fluid cartridges for micro-fluid ejection heads. In one or more exemplary embodiments, the multi-function thermoplastic elastomer layer is disposed in the exit port and on at least a portion of an outer surface of the reservoir.

Another exemplary embodiment of the disclosure provides a method for establishing a face seal surface adjacent to an exit port of a removable fluid reservoir before the fluid reservoir is attached to a micro-fluid ejection head. According to the method a replaceable fluid reservoir is provided. A multi-function thermoplastic elastomer layer is attached to the fluid reservoir and disposed adjacent to the exit port and on at least a portion of an outer surface of the reservoir. The multi-function thermoplastic elastomer layer provides a slip-resistant surface for gripping the fluid reservoir on the portion of the outer surface of the reservoir. The multi-function thermoplastic elastomer layer also provides a face seal surface by which the reservoir may be fluidically sealed to an ejection head when the reservoir is engaged with an ejection head.

Yet another exemplary embodiment of the disclosure provides a method for establishing a radial seal adjacent to an exit port of a removable fluid reservoir before the fluid reservoir is attached to a micro-fluid ejection head. According to the method a replaceable fluid reservoir and a shipping member are provided. A multi-function thermoplastic elastomer layer is disposed within the exit port and on at least a portion of an outer surface of the reservoir. The multi-function thermoplastic elastomer layer provides a slip-resistant surface for gripping on the portion of the outer surface of the reservoir, and provides a radial seal along the inner surface of the exit port between the reservoir and the shipping member when the shipping member is inserted into the exit port of the reservoir to retain the fluid in the reservoir during shipping and storage.

An advantage of the exemplary embodiments described herein is that a unitary component may be used in place of multiple components to enable enhanced assemble of components for replaceable fluid reservoirs. Use of a unitary component may also eliminate several steps required for assembling and packaging a fluid reservoir for shipment, storage, and provide easy engagement and removal from an ejection head. Separate gaskets or sealing members between the fluid reservoir and ejection head may also be eliminated by use of the multi-function thermoplastic elastomer layer.

### BRIEF DESCRIPTION OF THE DRAWINGS

Further features and advantages of the disclosed embodiments may become apparent by reference to the detailed description when considered in conjunction with the figures, which are not to scale, wherein like reference numbers indicate like elements through the several views, and wherein:

FIG. 1 is perspective view, not to scale, of a multi-cartridge carrier containing multiple replaceable fluid reservoirs for a micro-fluid ejection device;

FIG. 2 is perspective view, not to scale, of a replaceable fluid reservoir for a micro-fluid ejection device;

FIG. 3 is a cross-sectional view, not to scale, of an engagement area of a replaceable fluid reservoir for a micro-fluid ejection device;

FIG. 4 is a cross-sectional view, not to scale, of a replaceable fluid reservoir and a portion of a micro-fluid ejection head structure for connection to the replaceable fluid reservoir;

FIG. 5 is a cross-sectional view, not to scale, of an engagement area of a replaceable fluid reservoir for a micro-fluid ejection device including a shipping member;

FIG. 6 is a cross-sectional view, not to scale, of an engagement area of a replaceable fluid reservoir for a micro-fluid ejection device including a removable shipping member and removable film layer according to one exemplary embodiment;

FIG. 7 is a cross-sectional view, not to scale, of an engagement area of a replaceable fluid reservoir for a micro-fluid ejection device including a removable shipping member and removable film layer according to another exemplary embodiment; and

FIG. 8 is a diagram listing the steps for method for sealing an exit port of a removable fluid reservoir for a micro-fluid ejection head and for installing the fluid reservoir on a micro-fluid ejection head.

### DETAILED DESCRIPTION OF THE PREFERRED EMBODIMENTS:

In general, the disclosure is directed to replaceable fluid reservoir structures containing a multi-function thermoplastic elastomer layer and in particular to replaceable fluid reservoir structures providing improved fluidic connections between the replaceable fluid reservoirs and permanent or semi-permanent micro-fluid ejection heads while simultaneously providing a slip-resistant surface for gripping the reservoirs. For example, ink jet printers containing at least one permanent or semi-permanent micro-fluid ejection head desirably include a fluid reservoir that is easily replaced by a user when the fluid in the container is depleted. Typically, ink jet printers include two or more micro-fluid ejection heads and thus may include fluid reservoirs for each of the micro-fluid ejection heads.

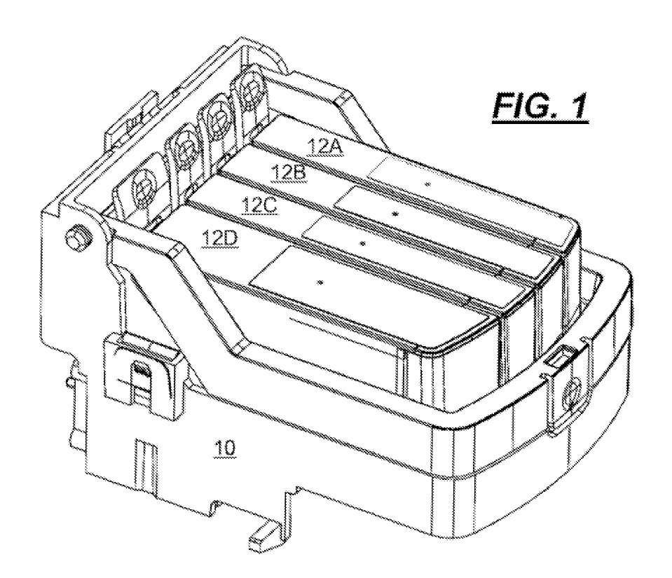

By way of illustration, FIG. 1 provides a micro-fluid ejection head carrier 10 containing multiple, removable fluid reservoirs 12A-12D. During replacement of the fluid reservoir 12B, for example, it is very important that reservoir 12B be easy to grasp so that the removal of the reservoir 12B and replacement with a fresh reservoir transpire with minimum disturbance to other fluid reservoirs (12A, 12C, and 12D) and minimum undesired fluid discharge from the reservoir 12B and the replacement reservoir.

FIG. 2 provides an illustrative example of one exemplary embodiment of the disclosure that provides a replaceable fluid reservoir 20 having a reservoir body 26, an exit port 22 formed therein, and a multi-function thermoplastic elastomer layer 24 attached to a portion of the reservoir body 26. The exit port 22 allows for fluid to flow from the reservoir 20 to a micro-fluid ejection head (not shown) when the reservoir 20 is engaged with a micro-fluid ejection head. The multi-function thermoplastic elastomer layer 24 is desirably slip-resistant so that the reservoir 20 is easy to grasp, remove, and replace. As illustrated in FIG. 2, the elastomer layer 24 may include one or more ridges 25 or other structures for non-slip grasping of the fluid reservoir 20.

The multi-function thermoplastic elastomer layer 24 may be made of thermoplastic vulcanizates (TPVs, TPEs, TPOs) made by a dynamic vulcanization process that provides a chemically cross-linked rubbery phase. Those skilled in the art appreciate that the multi-function thermoplastic elastomers discussed herein may be made up of a variety of materials, including, but not limited to, TPU_(polyurethane elasomers), PET elastomers (Hytrol), and SCBS (Krayton). Moreover, the term “layer” as used as part of the description for the multi-function thermoplastic elastomer throughout this disclosure is not meant to be limited to a single layer. Rather, the term “layer” may refer to one or more layers of a multi-functional thermoplastic elastomer.

The thickness of the multi-function thermoplastic elastomer layer 24 may range from about 0.5 mm (units) to about 1.5 mm (units). The hardness of the multi-function thermoplastic elastomer layer 24 may range from about 10 durometer to about 70 durometer.

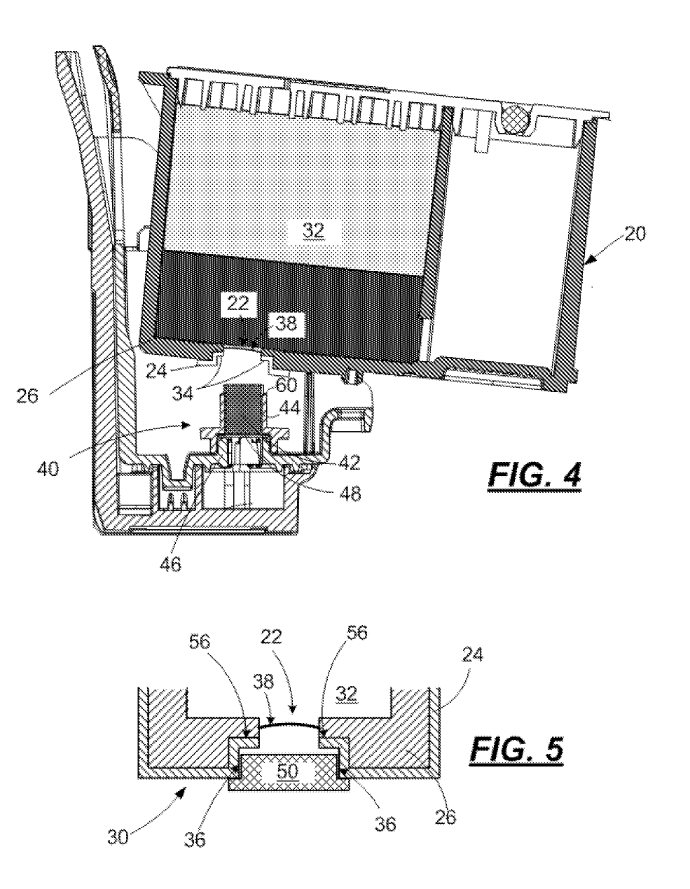

With reference to FIGS. 1-3, and with additional reference to FIGS. 4-7, the reservoir body 26 can be of one-piece molded plastic construction that may be made of a first material that is selected to be economical and have a high chemical resistance to the fluid(s) to be contained by the reservoir body 26. Suitable materials which may be used in manufacture of the reservoir body 26 for holding fluids such as inks of the type commonly used in inkjet printing include polypropylene and high density polyethylene (HDPE). Other suitable materials may include a polymeric material selected from the group consisting of amorphous thermoplastic polyetherimide available from G.E. Plastics of Huntersville, N.C. under the trade name ULTEM 1010, glass filled thermoplastic polyethylene terephthalate resin available from E. I. du Pont de Nemours and Company of Wilmington, Del. under the trade name RYNITE, syndiotactic polystyrene containing glass fiber available from Dow Chemical Company of Midland, Mich. under the trade name QUESTRA, polyphenylene oxide/high impact polystyrene resin blend available from G.E. Plastics under the trade names NORYL SE1 and polyamide/polyphenylene ether resin available from G.E. Plastics under the trade name NORYL GTX. Still other materials that may be used for the reservoir body 26 include, but are not limited to, polypropylene (PP), polymethylmethacrylate (PMMA), polycarbonate (PC), styrene-acrylonitrile (SAN), polypropylene/ethylene-propylene-diene monomer (PP/EPDM), polyvinylchloride with plasticizer (PVC-W), polybutyleneterephthalate (PBT), polysulfone (PSU), and thermoplastic polyurethane (TPU).

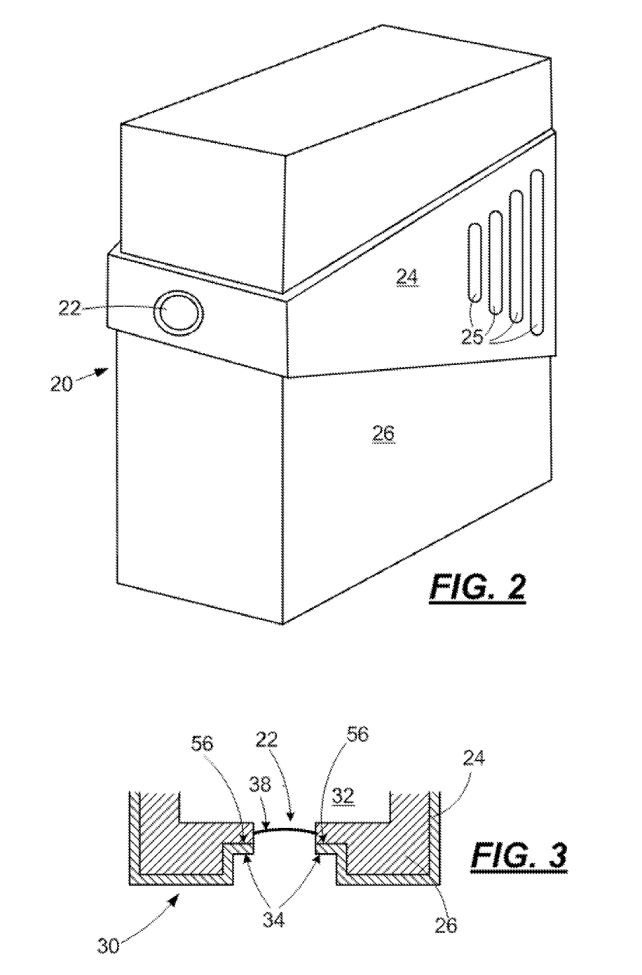

FIG. 3 provides a partial cross-sectional view of an engagement area 30 by which the fluid reservoir 20 is attachable to a micro-fluid ejection head. FIG. 3 also shows a portion of the reservoir body 26, the multi-function thermoplastic elastomer layer 24, details of the exit port 22, and a fluid chamber 32 internal to the reservoir body for holding fluids to be ejected by a micro-fluid ejection head. As shown in FIG. 3, the multi-function thermoplastic elastomer layer 24 provides a face seal area 34 that may be used for creating a fluidic seal between the fluid reservoir 20 and a micro-fluid ejection head as described with reference to FIG. 4.

A partial cross-sectional view illustrating engagement between the fluid reservoir 20 and a micro-fluid ejection head wick and filtration structure 40 is illustrated in FIG. 4. The wick and filtration structure 40 includes a wick 42, a wick retainer 44, and a filter tower component 46 containing a filtration element 48. As described above, the reservoir body 26 includes a multi-function thermoplastic elastomer layer 24 thereon that provides a face seal area 34 in the exit port 22. The wick 42 is inserted into the exit port 22 when the fluid reservoir 20 is attached to the wick and filtration structure 40. A septum 38 or other thin layer may be used in the exit port 22 to keep fluid from exiting the exit port 22 until the fluid reservoir 20 is attached to a micro-fluid ejection device. A face seal area 34 is shown where the wick and filtration structure 40 contacts the multi-function thermoplastic elastomer layer 24, creating a fluidic seal between the reservoir body 26 and the wick and filtration structure 40.

FIG. 5 illustrates yet another embodiment of the disclosure including a partial cross-sectional view showing the engagement area 30 by which the fluid reservoir body 26 is attached to a shipping member 50. FIG. 5 further shows the exit port 22, the multi-function thermoplastic elastomer layer 24, and the fluid chamber 32. A radial seal area 36 is shown where the shipping member 50 contacts the multi-function thermoplastic elastomer layer 24, creating a fluidic seal between the reservoir body 26 and the shipping member 50. In the embodiment illustrated in FIG. 5, the shipping member 50 appears as a shipping “plug.” However, any object used to accomplish the purpose of blocking fluid from flowing out of a fluid reservoir through exit port 22 during shipping or storage will suffice for the purposes of this disclosure.

For example, FIG. 6 illustrates the use of what may be described as a shipping “clip” instead of the shipping member 50. More specifically, FIG. 6 illustrates a partial cross-sectional view showing the engagement area 30 by which a fluid reservoir body 26 is attached to a shipping clip 52. As with the shipping plug 50, a radial seal area 37 is provided where the shipping clip 52 contacts the multi-function thermoplastic elastomer layer 24, thereby creating a fluidic seal between the reservoir body 26 and the shipping clip 52.

A removable film layer 54 may be removably attached to the fluid reservoir body 26 and substantially fixedly attached to the shipping clip 52 so that when the film layer 54 is removed from the reservoir body 26, the shipping member 52 will be removed from the exit port 22. The removable film layer 54 may be made of Polypropylene, but those skilled in the art appreciate that the removable film discussed herein may be made up of a variety of materials, including, but not limited to Polyethylene, EVOH and the like. As with the multi-function thermoplastic elastic layer 24, the film layer 54 may include one or more layers of film material. A release material may applied to at least a portion of the reservoir body 26, or on at least a portion of the thermoplastic elastomer layer 24 to aid in removing the removable film layer from the body 26 or elastomer layer 24.

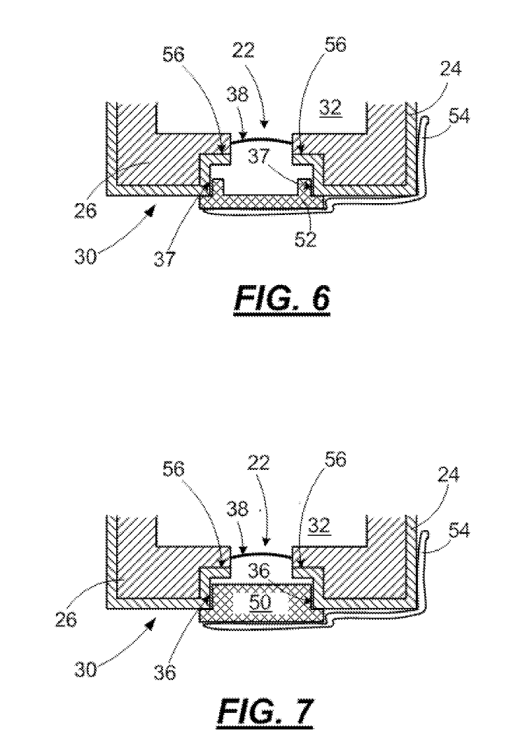

FIG. 7 illustrates an embodiment similar to the embodiment shown in FIG. 5 wherein the shipping member 50 is inserted into the exit port 22 of the reservoir body 26. As in FIG. 5, there is the radial seal area 36 where the shipping member 50 contacts the multi-function thermoplastic elastomer layer 24, creating a fluidic seal between the reservoir body 26 and the shipping member 50. In order to aid in the removal of the shipping member 50 from the reservoir body, the removable film layer 54 may be removably attached to the fluid reservoir body 26 and substantially fixedly attached to the shipping member 50 so that when the film layer 54 is removed from the reservoir body 26, the shipping member 50 will be removed from the exit port 22 of the reservoir body.

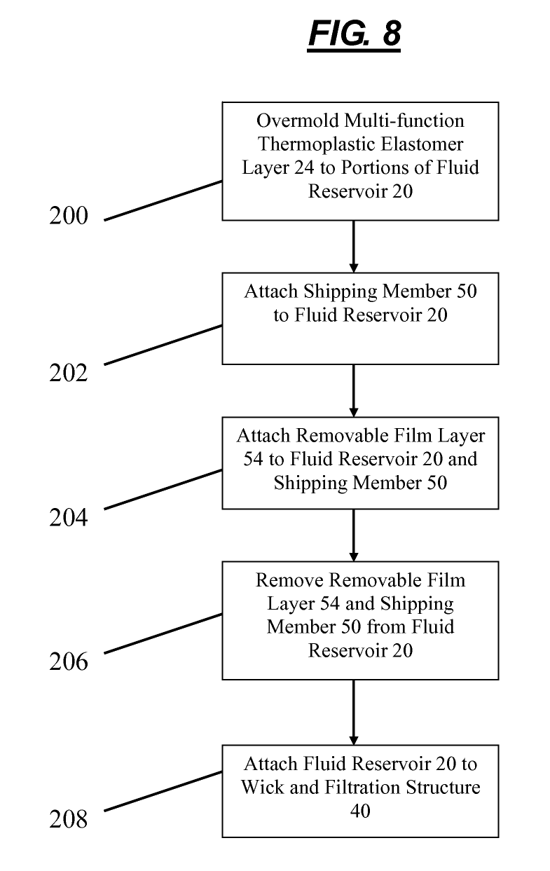

Exemplary embodiments described herein are also directed to methods of handling and shipping removable fluid reservoirs for micro-fluid ejection heads. Each of the removable fluid reservoirs includes the multi-function thermoplastic elastomer layer 24 described above. In FIG. 8, there is shown a block diagram of a process for making and handling removable fluid reservoirs according to the disclosed embodiments. In a first step 200 of the process, the replaceable fluid reservoir 20 having the exit port 22 is overmolded with the multi-functional thermoplastic elastomer layer 24 so that the layer is provided on a portion of the body 26 of the reservoir 20 and in the exit port 22 as illustrated in FIGS. 2 and 3. The thermoplastic elastomer layer 24 substantially coats a shoulder 56 of the exit port 22 as well as a portion of the body 26 of the fluid reservoir 20. The thermoplastic elastomer layer 24 coated over the shoulder 56 defines the face seal area 34 by which the fluid reservoir 20 may be attached to a micro-fluid ejection head.

In a second step 202 of the process, the shipping member 50 or clip 52 may be attached to the fluid reservoir 20 in the exit port 22. The radial seal in the radial seal area 36 or 37 is provided where the shipping member 50 or clip 52 contacts the multi-function thermoplastic elastomer layer 24 to provide a fluidic seal between the fluid reservoir 20 and the shipping member 50 or clip 52.

In one embodiment of the disclosure, the removable film layer 54 is attached to the fluid reservoir 20 and the shipping member 50 or clip 52 as shown in step 204. As described above, the film layer 54 is removably attached to the fluid reservoir 20 or elastomer layer 24 and is substantially fixedly attached to the shipping member 50 or 52. At this point, the fluid reservoir 20 may be shipped and handled without undesirable leakage of fluid from the fluid reservoir 20.

Prior to attaching the fluid reservoir 20 to a micro-fluid ejection head, the removable film layer 54 is removed from the fluid reservoir body 26 or elastomer layer 24. As the film layer 54 is removed, the shipping member 50 or 52 remains attached to the film layer 54 and is thereby removed from the exit port 22 of the fluid reservoir 20 as provided in step 206 of the process.

In step 208, the fluid reservoir 20 is disposed in the carrier 10 so that the reservoir 20 is attached to the wick and filtration structure 40 as shown with reference to FIGS. 1 and 4. As the reservoir is attached to the wick and filtration structure 40 so that the wick is disposed in the exit port 22, the septum or membrane, if any, is broken so that there is fluid flow communication established between the fluid chamber 32 of the reservoir 20 and the wick and filtration structure 40. As shown in FIG. 4, ends 60 of the wick retainer 44 contact face seal area 34, thereby creating a fluidic seal between the fluid reservoir 20 and the wick and filtration structure 40.

In the absence of the use of the shipping member 50 or clip 52, the foregoing process may be simplified into the two steps 200 and 208 of overmolding the multi-function thermoplastic elastomer layer 24 onto the fluid reservoir 20 and attaching the fluid reservoir 20 to the wick and filtration structure 40.

Having described various aspects and embodiments of the disclosure and several advantages thereof, it will be recognized by those of ordinary skills that the embodiments are susceptible to various modifications, substitutions and revisions within the spirit and scope of the appended claims.

What is claimed is:

1. A replaceable tank for attachment to a micro-fluid ejection head, the tank comprising
a. a substantially enclosed fluid reservoir, the substantially enclosed reservoir having at least one exit port therein for fluid flow out of the reservoir; and
b. a multi-function thermoplastic elastomer layer disposed in the exit port and on at least a portion of an outer surface of the reservoir.

2. The replaceable tank of claim 1, wherein the multi-function thermoplastic elastomer layer provides a slip-resistant surface for gripping the tank.

3. The replaceable tank of claim 1, wherein the multi-function thermoplastic elastomer layer provides a radial seal for a shipping member disposed in the exit port.

4. The replaceable tank of claim 1, wherein the multi-function thermoplastic elastomer layer provides a face seal when the tank is attached to a micro-fluid ejection head.

5. The replaceable tank of claim 1, wherein the multi-function thermoplastic elastomer layer comprises a dynamically vulcanized polyolefin.

6. A method for sealing an exit port of a removable fluid reservoir for a micro-fluid ejection head, the method comprising depositing a multi-function thermoplastic elastomer layer onto a substantially enclosed fluid reservoir, the reservoir having at least one exit port therein for fluid flow out of the reservoir whereon the multi-function thermoplastic elastomer layer is disposed in the exit port and on at least a portion of an outer surface of the reservoir, whereby the elastomer layer substantially forms a face seal surface adjacent the at least one exit port.

7. The method of claim 6, wherein the elastomer layer forms a radial seal surface in the at least one exit port, further comprising the step of attaching a shipping member to the at least one exit port to provide a radial seal between a lateral surface of the shipping member and the multi-function thermoplastic elastomer layer.

8. The method of claim 6 further comprising the step of attaching the removable fluid reservoir to a micro-fluid ejection head whereby an extension member of the micro-fluid ejection head is inserted into the at least one exit port such that fluid flow is established between the reservoir and the micro-fluid ejection head and whereon a face seal is formed between the multi-function thermoplastic elastomer layer and the extension member.

9. The method of claim 6, wherein the depositing step comprises overmolding the multi-function thermoplastic onto the outer surface of the fluid reservoir.

10. The method of claim 7 wherein the shipping member includes a portion that is weldable to said reservoir, said portion being separable from said reservoir via a twisting motion.

11. The method of claim 7 further comprising attaching a removable film layer onto a portion of the surface of the shipping member and onto at least a portion of the multi-function thermoplastic elastomer layer for removing the shipping member from the exit port.

12. The method of claim 10 further comprising the step of removing the film layer from the portion of the multi-function thermoplastic elastomer layer to which the film layer is attached, whereby the shipping member remains substantially attached to the film layer, thereby removing the shipping member and the film layer from the reservoir.

13. A method for improving the handling and shipping of replaceable fluid cartridges for micro-fluid ejection heads, the method comprising depositing a multi-function thermoplastic elastomer layer onto a substantially enclosed fluid reservoir, the reservoir having at least one exit port therein for fluid flow out of the reservoir, wherein the multi-function thermoplastic elastomer layer is disposed in the exit port to provide a radial seal surface in the at least one exit port.

14. The method of claim 12, wherein the multi-function thermoplastic elastomer layer further comprises a slip-resistant surface for gripping the replaceable fluid cartridge.

15. The method of claim 12, further comprising the step of attaching a shipping member to the at least one exit port to provide a radial seal between a lateral surface of the shipping member and the radial seal surface in the at least one exit port.

16. The method of claim 12, wherein the depositing step comprises overmolding the multi-function thermoplastic onto an outer surface of the fluid reservoir.

17. The method of claim 14 further comprising attaching a removable film layer onto a portion of the surface of the shipping member and onto at least a portion of the multi-function thermoplastic elastomer layer for removing the shipping member from the exit port.

18. The method of claim 16 further comprising the step of removing the film layer from the portion of the multi-function thermoplastic elastomer layer to which it is attached, whereby the shipping member remains substantially attached to the film layer, thereby removing the shipping member and the film layer from the reservoir.
